(19) United States
(12) Patent Application Publication
(10) Pub. No.: US 2024/0120507 A1
(43) Pub. Date: Apr. 11, 2024

(54) Process for producing a lightweight bipolar plate for an electrochemical device

(71) Applicant: Airbus (S.A.S.), Blagnac (FR)

(72) Inventors: Christian Metzner, Gmund (DE); Michael Hofmann, Neubiberg (DE); Florian Vogel, Unterhaching (DE); Jürgen Steinwandel, Uhldingen-Mühlhofen (DE); Helmut Piringer, Oberpframmern (DE)

(21) Appl. No.: 18/198,614

(22) Filed: May 17, 2023

(30) Foreign Application Priority Data
May 20, 2022 (EP) 22174596.1

(51) Int. Cl. H01M 8/0213; H01M 8/0247; H01M 8/0267

(52) U.S. Cl. CPC H01M 8/0213; H01M 8/0247; H01M 8/0267

(57) ABSTRACT

A process is proposed for producing a bipolar plate for an electrochemical device, said process comprising providing a first main plate body and a second main plate body as fibrous shaped bodies including carbon fibers and each having a joining face and an opposing useful face, infiltrating the main plate bodies with at least one carbon allotrope, locally applying silicon to respective joining sites in the joining faces, placing the joining faces against one another, such that the joining sites rest against one another and the useful faces of the two main plate bodies face away from one another, and at least locally heating the joining sites, such that the silicon melts and reacts with adjoining carbon to form a silicon-carbon bond.

### TECHNICAL FIELD

The present description relates to a process for producing a bipolar plate for an electrochemical device, to a bipolar plate for an electrochemical device, and to an electrochemical device having at least one such bipolar plate.

### TECHNICAL BACKGROUND

An electrochemical device in the context of the invention may especially be a fuel cell stack having multiple fuel cells that are supplied with oxygen and hydrogen. The electrochemical device may additionally also be an electrolyzer with which oxygen and hydrogen can be produced. Fuel cell stacks as used in aircraft, for example, often have PEM fuel cells. In these, a fundamental electrochemical functional unit is implemented in the form of what is called a membrane-electrode assembly, having an electrolyte, anode and cathode catalysts that surround the electrolyte, and gas diffusion layers that adjoin them on the outside. The electrolyte in the case of low-temperature fuel cells could, for instance, comprise Nation or the like. In the case of high-temperature fuel cells, it would be possible to use, for instance, phosphoric acid-doped polybenzimidazoles.

The bipolar plates separate individual electrochemical cells fluidically from one another and simultaneously implement the electrical interconnection thereof. The bipolar plates typically consist of two joined halves, may have a channel for water cooling of the fuel cells, and additionally serve to lead off the electrical current. On either side of the bipolar plates, fine channel structures have been introduced, which are referred to as flow field and serve to guide hydrogen to the anode and oxygen or air to the cathode side over a large area. The bipolar plates are therefore essential active components of a fuel cell stack.

A material often used for bipolar plates is stainless steel with a specific weight of up to 8 g/cm³, Depending on their thickness, these metallic bipolar plates account for up to about 70% of the weight of a fuel cell stack.

In the production of a bipolar plate, two separate plate halves are typically provided and welded to one another. There are widely used mechanical methods for introducing the flow fields. For instance, flow fields can be introduced into the individual plate halves by embossing methods. In isolated cases, bipolar plates made of a titanium base alloy are also used. It is thus possible to reduce the weight of the bipolar plates to about half. However, production is problematic, since, firstly, particularly thin titanium foils having a wall thickness of less than 150 μm are of limited availability, and the welding of these foils is complex.

Metallic bipolar plates also require an anticorrosion layer. In order to assure the actual function of the bipolar plate, it must be electrically conductive. This can be achieved, for instance, by nickel, molybdenum, tantalum or mixtures thereof. Coating methods may include, for instance, physical or chemical gas phase deposition (PVD or CVD), thermal spraying with a flame or plasma as energy carrier, sol-gel layers or the like.

As well as metallic bipolar plates, bipolar plates made of pure graphite or a graphite composite are additionally also known, with use of machining, hot pressing or injection molding for shaping. However, the joining of the plates while maintaining electrical and thermal conductivity is complex.

### DESCRIPTION

The problem addressed can therefore be considered to be that of proposing a process for producing a bipolar plate for an electrochemical device in which a bipolar plate with minimum weight is producible in a very inexpensive and reliable manner.

The object is achieved by a process having the features of independent claim 1. Advantageous embodiments and developments can be found in the dependent claims and the description that follows.

A process is proposed for producing a bipolar plate for an electrochemical device, said process comprising providing a first main plate body and a second main plate body as fibrous shaped bodies including carbon fibers and each having a joining face and an opposing useful face, infiltrating the main plate bodies with at least one carbon allotrope, locally applying silicon to respective joining sites in the joining faces, placing the joining faces against one another, such that the joining sites rest against one another and the useful faces of the two main plate bodies face away from one another, and at least locally heating the joining sites, such that the silicon melts and reacts with adjoining carbon to form a silicon-carbon bond.

The fibrous shaped bodies here are essentially flat plate halves. They may have an edge contour matched directly to the required size of the bipolar plate. However, it is conceivable that the step of infiltrating the fibrous shaped bodies is followed by a mechanical final processing operation in which the fibrous shaped body is brought to desired final dimensions.

The fiber material of the main plate bodies serves as matrix or carrier and is densely infiltrated with a suitable carbon allotrope, such that an electrically and thermally highly conductive and preferably pore-free and fluid-tight arrangement is formed. The at least one carbon allotrope may comprise graphite, graphene structures, fullerenes or others. It is conceivable to infiltrate the main plate body with graphite. It may be advisable here, as the case may be, to add graphite platelets in order to further increase electrical conductivity.

The infiltrating may be conducted, for instance, by chemical vapor infiltration. The respective useful face is the face into which the flow field is integrated at a later stage and toward which the respective membrane-electrode assembly is directed.

After the infiltrating, the main plate bodies may be pressed and/or heated or processed in some other way in order to increase their stability.

The bipolar plates may firstly be left in an unsintered state, such that two phases are formed. Depending on the carbon allotropes used, however, these may also be pressed or hardened. Alternatively, there may be a subsequent sintering operation, in which case the carbon allotrope that has been introduced by infiltration is sintered virtually to give a solid material.

It is further conceivable to sinter the bipolar plates beforehand or, as the case may be, in the same temperature cycle, in order to be able to bond them by means of silicon, in order to achieve higher thermal stability of the carbon allotrope that has been introduced by infiltration.

A core aspect of the process of the invention lies in the local applying of silicon to joining sites. The joining sites may especially be provided at the edge of the main plate bodies. It is conceivable to provide only one of the two main plate bodies with silicon. The placing of the main plate bodies one on top of another then causes the two main plate bodies to come into contact with the silicon.

The at least local heating of the joining sites results in melting of the silicon, which forms a Si—C or SiSi—C bond with the adjoining carbon. This bonds the two main plate bodies to one another. Graphite and carbon fibers have high thermal stability, such that both heating at the edge and heating of the entirety of the two main plate bodies above the melting temperature of silicon, which is 1414° C., is unproblematic for the integrity of the main plate bodies.

The process of the invention produces a bipolar plate having a very low specific weight of about 2.3 g/cm³, which is well below the specific weight of bipolar plates produced from metallic materials. The bipolar plate produced additionally has good thermal and electrical conductivity. In addition, it is completely corrosion-resistant under the normal operating conditions of the fuel cell. The materials used for the production are available inexpensively and industrially on a large scale. The bipolar plate has excellent thermal properties and a high anisotropy ratio in respect of thermal conductivity. By adjusting the structure of the fibrous shaped bodies and the content of graphite, it would be possible to further optimize the thermal properties.

The joining sites could be arranged in radially outer edge regions of the main plate bodies. The main plate bodies are therefore bonded to one another in their edge regions. The edge regions may take the form of circumferential regions in the form of strips.

The silicon could be disposed at the joining sites in the form of wire and/or in the form of powder. The wire could be implemented as a circumferential wire with one or more loops. In addition, it would also be possible to dispose individual, relatively short wire sections at the joining sites. In order to achieve initial adhesion of the silicon, whether in the form of wire or powder, on the main plate bodies, it is conceivable to use a bonding agent which is degraded on welding and especially evaporates.

It is conceivable that the at least local heating comprises the introducing of the arrangement of main plate bodies and silicon into a kiln and heating by means of the kiln. Consequently, the entire arrangement that forms the bipolar plate is heated in a kiln, such that the silicon melts locally at the joining sites and leads to a bond between the two main plate bodies. It is thus possible to guarantee uniform heating, such that a uniform bond is made between the main plate bodies.

However, the at least local heating could also comprise the local heating at least of the joining sites with a laser or a plasma beam. The laser beam or plasma beam may be guided over the outside of an edge region, such that the main plate body exposed to the laser beam or plasma beam is heated and the silicon is heated and melted by conduction of heat.

The local heating could comprise the heating of a circumferential edge section of the arrangement of main plate bodies and silicon. The edge section could be heated from the radial or axial direction or a combination thereof. A heat source may consequently follow the edge section axially or radially.

The method may further include the introducing of flow channels into the useful faces. In this way, the flow fields are formed. The flow channels may be in a meandering distribution over the two useful faces and include a connection region via which a fluid connection to an external fluid source or fluid sink can be established.

The introducing of flow channels could be conducted by at least one removal method selected from a group of removal methods comprising the group of mechanical removal methods, spark erosion, ablative plasma methods, and ablative laser methods. The methods have different advantages and may be selected depending on the size, fineness, number of flow channels to be made, and the like.

The process may further comprise the applying of an electrically conductive coating to the useful faces. This coating could comprise alpha-C.

As elucidated above, the main plate bodies may be infiltrated with graphite in order to achieve high electrical conductivity.

It is advisable when graphite platelets are additionally introduced into the main plate body in order to further increase electrical conductivity.

The invention further relates to a bipolar plate produced by the aforementioned process. Consequently, a bipolar plate is defined, having a first main plate body and a second main plate body that take the form of fibrous shaped bodies having carbon fibers and each having a joining face and an opposite useful face, and have been infiltrated with at least one carbon allotrope, where the two main plate bodies have been joined at joining sites by means of molten silicon.

The invention further relates to the use of silicon for welding of two main plate bodies composed of a fibrous shaped body that includes carbon fibers and has been infiltrated with at least one carbon allotrope in order to form a bipolar plate.

### BRIEF DESCRIPTION OF THE FIGURES

There follows a more detailed discussion of working examples with reference to the appended drawings. The drawings are schematic and not true to scale. Identical reference numerals relate to identical or similar elements. The figures show:

FIG. 1 a schematic diagram of a process for producing a bipolar plate according to a working example.

FIG. 2 a schematic diagram of two main plate bodies for forming a bipolar plate.

FIG. 3 a schematic side view of a bipolar plate according to a working example.

### DETAILED DESCRIPTION OF WORKING EXAMPLES

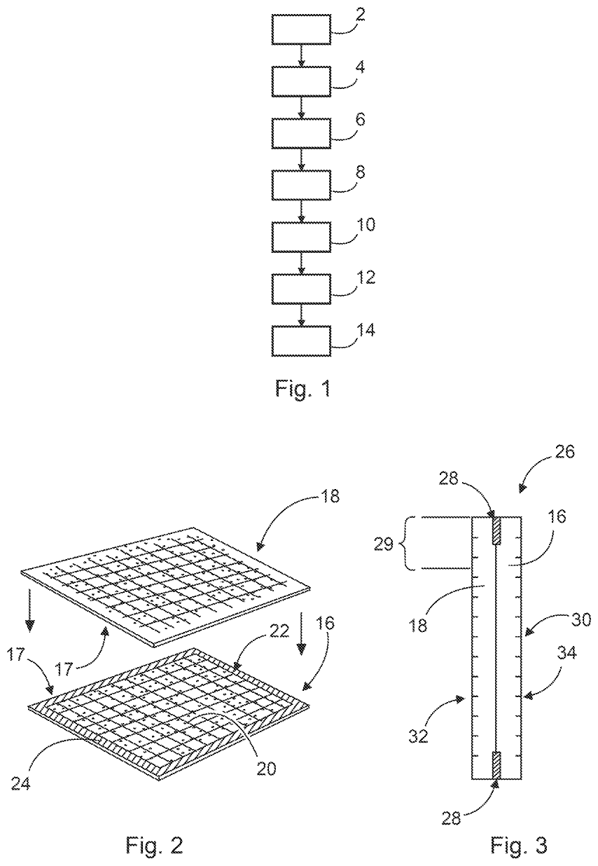

FIG. 1 shows a process for producing a bipolar plate for an electrochemical device. The process has the steps of providing 2 a first main plate body and a second main plate body as fibrous shaped bodies including carbon fibers and each having a joining face and an opposing useful face, infiltrating 4 the main plate bodies with at least one carbon allotrope, locally applying 6 silicon to respective joining sites in the joining faces, placing 8 the joining faces against one another, such that the joining sites rest against one another and the useful faces of the two main plate bodies face away from one another, and at least locally heating 10 the joining sites, such that the silicon melts and reacts with adjoining carbon to form a silicon-carbon bond. The process may at least optionally include the step of introducing 12 flow channels into the useful faces. The infiltrating may comprise infiltrating with graphite. In addition, it is also possible to introduce graphene platelets. The process may also include the step of applying 14 a coating to the useful faces,

FIG. 2 shows a first main plate body 16 and a second main plate body 18, each of which in the form of fibrous shaped bodies having carbon fibers. Both main plate bodies 16 and 18 have been infiltrated with a carbon allotrope 20, for example graphite and optionally additionally graphene platelets. Both main plate bodies 16 and 18 have a joining face 17, with joining sites 22 provided at the edge in each case. Silicon 24 has been applied to the joining sites 22, for example in the form of powder or wire. The main plate bodies 16 and 18 are placed one on top of another by their joining sites 22, such that the joining faces 17 face one another. This is indicated by movement arrows. Subsequent heating leads to melting of the silicon 24, such that a silicon-carbon bond with adjoining carbon is established. The two main plate bodies 16 and 18 are thus bonded to one another in a fluid-tight manner.

This results in a bipolar plate 26 shown in FIG. 3. The molten silicon 24 is indicated here as a weld bond 28, This is in the region of a circumferential edge section 29 that can be selectively heated for melting of the silicon 24. Alternatively, as elucidated above, the entire arrangement composed of main plate bodies 16 and 18 and silicon 24 may also be heated in a kiln, so as to result in the weld bond 28 depicted here.

On a first useful face 30 of the first main plate body 16 and a second useful face 32 of the second main plate body 18, each of which faces away from the joining faces 17, flow channels 34 are provided in each case. These may be introduced into the useful faces 30 and 32 by mechanical removal methods, spark erosion, ablative plasma methods, or ablative laser methods.

It should additionally be pointed out that “comprising” or “having” does not rule out any other elements or steps, and “a” does not rule out a multitude. It should additionally be pointed out that features or steps that have been described with reference to one of the above working examples can also be used in combination with other features or steps of other working examples described above. Reference numerals in the claims should not be regarded as a restriction.

### LIST OF REFERENCE NUMERALS

2 providing
4 infiltrating
6 locally applying
8 placing
10 locally heating
12 introducing
14 applying
16 first main plate body
17 joining face
18 second main plate body
20 carbon allotrope
22 joining site
24 silicon
26 bipolar plate
28 weld bond
29 edge section
30 first useful face
32 second useful face
34 flow channel

1. A process for producing a bipolar plate for an electrochemical device, comprising:
providing a first main plate body and a second main plate body as fibrous shaped bodies including carbon fibers and each having a joining face and an opposing useful face;
infiltrating the first and second main plate bodies with at least one carbon allotrope;
locally applying silicon to respective joining sites in the joining faces;
placing the joining faces against one another, such that the joining sites rest against one another and the useful faces of the first and second main plate bodies face away from one another; and
at least locally heating the joining sites, such that the silicon melts and reacts with adjoining carbon to form a silicon-carbon bond.

2. The process of claim 1,
wherein the joining sites are disposed in radially outer edge regions of the main plate bodies.

3. The process of claim 1,
wherein the silicon is disposed at the joining sites in a form of wire and/or powder.

4. The process of claim 1,
wherein the at least local heating comprises introducing the first and second main plate bodies and silicon into a kiln and heating by the kiln.

5. The process of claim 1,
wherein the at least local heating) comprises the local heating at least of the joining sites with a laser or a plasma beam.

6. The process of claim 2,
wherein the local heating comprises heating of a peripheral edge section of the first and second main plate bodies and silicon.

7. The process of claim 1, further comprising introducing of flow channels into the useful faces.

8. The process of claim 7,
wherein the introducing of flow channels is conducted by at least one removal method selected from:
mechanical removal methods;
spark erosion;
ablative plasma methods; and
ablative laser methods.

9. The process of claim 1, further comprising applying a coating to the useful faces.

10. The process of claim 1,
wherein the first and second main plate bodies are infiltrated with graphite.

11. The process of claim 10,
wherein the main plate bodies are additionally infiltrated with graphene platelets.

12. A bipolar plate produced by the process of claim 1.

13. A method of using silicon for welding of two main plate bodies composed of a fibrous shaped body that includes carbon fibers and has been infiltrated with at least one carbon allotrope to form a bipolar plate.
